(19) United States
(12) Patent Application Publication
(10) Pub. No.: US 2004/0162780 A1
(43) Pub. Date: Aug. 19, 2004

(54) Methods and apparatus for integrating one-way and two-way security systems to enable secure distribution of encrypted services

(75) Inventor: Robert C. Booth, Jamison, PA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 10/368,845

(22) Filed: Feb. 19, 2003

(51) Int. Cl. G06F 17/60

(52) U.S. Cl. 705/50

(57) ABSTRACT

The present invention provides methods and apparatus for integrating one-way and two-way security systems to enable secure distribution of services. A decryption device securely receives and decrypts encrypted services from one or more service providers. A consumer device securely communicates with the decryption device. A user interface associated with the consumer device initiates a service request for a requested service from a service provider. In operation, the service request is communicated from the consumer device to the decryption device. The requested service is then acquired by the decryption device as an encrypted requested service. The acquired requested service is then decrypted by the decryption device. The requested service is re-encrypted and securely communicated from the decryption device to the consumer device. The re-encrypted requested service is then decrypted and decoded at the consumer device to provide the requested service.

### BACKGROUND OF THE INVENTION

The present invention relates to the fields of digital and streaming media communications, in-home networking, and digital communication security. More specifically, the present invention relates to the integration of one-way and two-way security systems to enable the secure distribution of encrypted services.

Television system operators, including cable and satellite television system operators, as well as off-air service providers, offer a large number of audio, video, and audiovisual services to their customers. Such services include standard television programming, pay-per-view television programming, on-demand programming, streaming media services, Internet services, and the like. However, the consumers receiving such services are typically limited to viewing the services on a particular television set associated with a television terminal (e.g., set-top box) provided by the television system operator.

Currently there is no mechanism to securely distribute encrypted audio and/or video content from a digital television terminal (such as a digital set-top box) to a remote television set or other consumer device in a manner that protects the interests of the content provider and the television system operator.

It would be advantageous to establish a secure environment for distributing audio and/or video content beyond the television terminal. It would be further advantageous if such distribution could be accomplished using an in-home network, by integrating a one-way security system provided, for example, in the television terminal, with a two-way security system provide, for example, in a web pad. Enabling such distribution would make television system operators more receptive to purchasing new products, such as web pads and the like. Further, television system operators would be able to assess additional service charges for such capability, as consumers would be able use their personal computers (or a web pad, or the like) to access services from their television terminals via the in-home network. Such a feature would drive the sales of television terminals that are so enabled.

The methods and apparatus of the present invention provide the foregoing and other advantages.

### SUMMARY OF THE INVENTION

The present invention relates to methods and apparatus for integrating one-way and two-way security systems to enable secure distribution of services. A decryption device is provided which is enabled to securely receive and decrypt encrypted services from one or more service providers. A consumer device is provided which is enabled to securely communicate with the decryption device. A user interface associated with the consumer device is provided for initiating a service request for a requested service from the one or more service providers. In operation, the service request is communicated from the consumer device to the decryption device. The requested service is then acquired by the decryption device from the one or more service providers in response to the service request as an encrypted requested service. The acquired encrypted requested service is then decrypted by the decryption device. The requested service is re-encrypted and securely communicated from the decryption device to the consumer device. The re-encrypted requested service can then be decrypted and decoded at the consumer device to provide the requested service.

Those skilled in the art will appreciate that the present invention may be implemented using software, hardware, and/or firmware.

### BRIEF DESCRIPTION OF THE DRAWINGS

The present invention will hereinafter be described in conjunction with the appended drawing figures, wherein like numerals denote like elements, and:

FIG. 1 shows a block diagram of an example embodiment of the present invention;

FIG. 2 shows a block diagram of an example embodiment of a decryption device in accordance with the present invention; and

FIG. 3 shows a block diagram of an example embodiment of a consumer device in accordance with the present invention.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

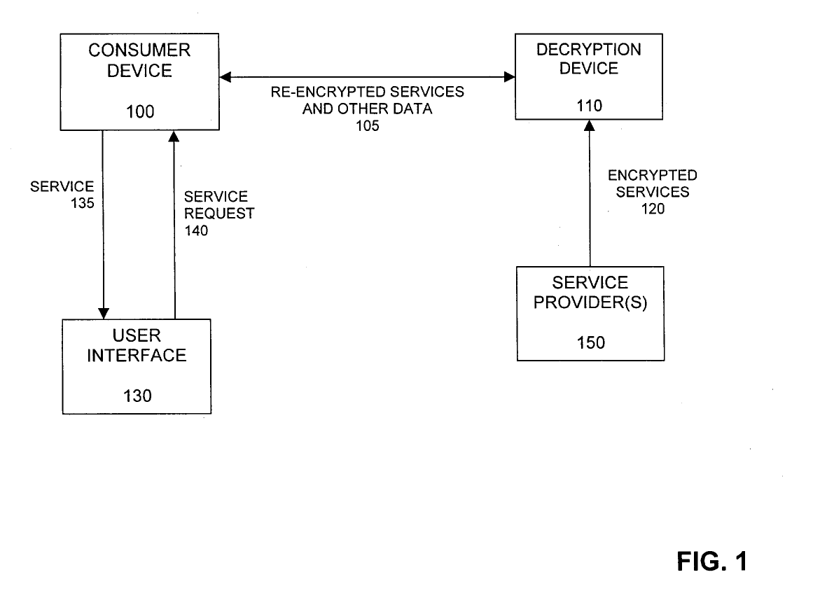

The present invention relates to methods and apparatus for integrating one-way and two-way security systems to enable secure distribution of services. As shown in FIG. 1, a decryption device 110 is provided which is enabled to securely receive and decrypt encrypted services 120 from one or more service providers 150. A consumer device 100 is provided which is enabled to securely communicate with the decryption device 110. A user interface 130 associated with the consumer device 100 is provided for initiating a service request 140 for a requested service 135 from the one or more service providers. In operation, the service request 140 is communicated from the consumer device 100 to the decryption device 110. The requested service is then acquired by the decryption device 110 from the one or more service providers in response to the service request as an encrypted requested service 120. The acquired encrypted requested service 120 is then decrypted by the decryption device 110. The requested service is re-encrypted and securely communicated from the decryption device 110 to the consumer device 100 (e.g., as re-encrypted service 105). The re-encrypted requested service 105 can then be decrypted and decoded at the consumer device 100 to provide the requested service 135.

The service request 140 may be communicated from the consumer device 100 to the decryption device 110 via one of a secure channel or a non-secure channel.

The requested service 135 may be securely acquired by the decryption device 110 from the service provider 150. The requested service 135 may be received by the decryption device in an encrypted multiplex of services (e.g., encrypted services 120). If so, the decryption device 110 may be adapted to decrypt the multiplex of services 120 in order to acquire the requested service 135.

The received encrypted services 120 may be received in a first encryption format and the re-encrypted requested service 105 may be encrypted in a second encryption format compatible with the consumer device 100.

The consumer device 100 may establish a secure socket layer (SSL) connection with the decryption device 110. The SSL connection may be enabled via one of a Transmission Control Protocol/Internet Protocol (TCP/IP) transport scheme, an MPEG-2 transport scheme, or any other type of transport scheme, including a proprietary transport scheme. The service request 140 may be securely communicated from the consumer device 100 to the decryption device 110 via the SSL connection.

The requested service 135 may be a parentally controlled service. In such an embodiment, the decryption device 110 may communicate a response to the consumer device 100 requesting access information for the parental controlled service. The access information may be provided by a user via the user interface 130. The access information may be securely communicated from the consumer device 100 to the decryption device 110. In the event the access information is verified by the decryption device 110, the user is authorized to receive the requested service 135. The access information may comprise at least one of a personal identification number, a user name, a password, or similar access control information.

The requested service 135 may be a pay-per-view service. The decryption device 110 may communicate a response to the consumer device 100 requesting payment or authorization information for the pay-per-view service. The payment or authorization information may be provided by a user via the user interface 130. The payment or authorization information may be securely communicated from the consumer device 100 to the decryption device 110. In the event the payment or authorization information is verified by the decryption device 110, the user is authorized to receive the requested pay-per-view service.

A smart card interface may be provided to enable the payment or authorization for the requested pay-per-view service. The smart card interface may be integrated into or part of the user interface 130, the consumer device 100, or the decryption device 110.

The consumer device 100 may comprise an Internet appliance, a personal computer, a personal digital assistant, a cellular telephone, or the like. The decryption device 110 may comprise a digital television terminal, a digital television, or the like. The user interface 130 may comprise one of an interactive display device, a remote control device adapted for communication with the consumer device, a touch screen associated with the consumer device, a joystick associated with the consumer device, a mouse, a touch pad associated with the consumer device, or any other similar type of interface.

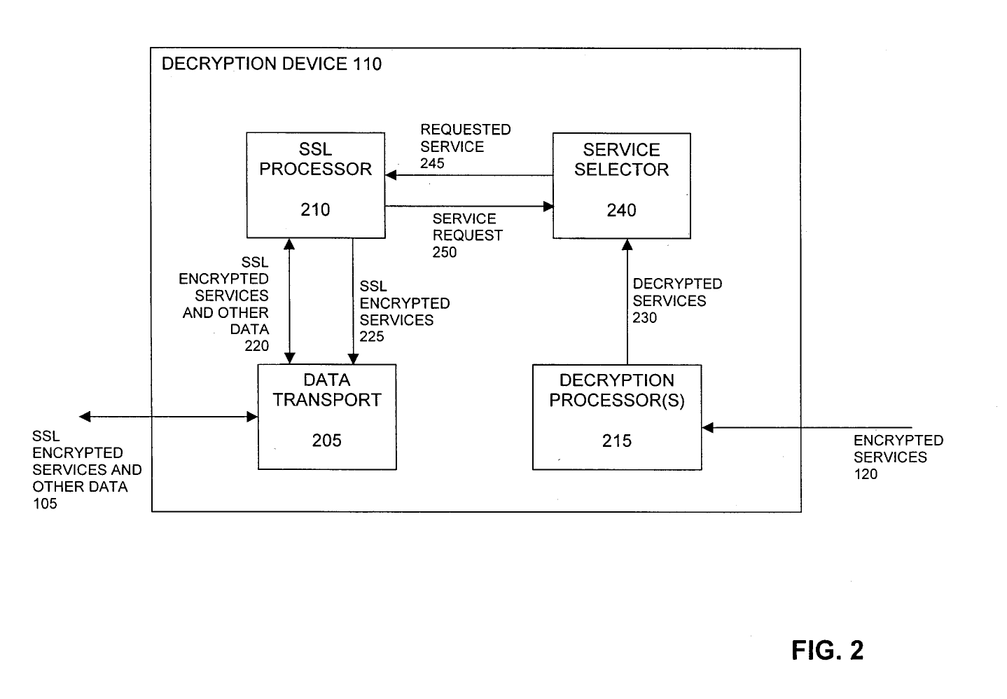

In an example embodiment of the invention as shown in FIG. 2, the decryption device 110 may comprise a first secure socket layer (SSL) processor 210 for enabling SSL communications and re-encrypting the requested service. A service selector 240 for acquiring the requested service (as an encrypted requested service 120) from the one or more service providers, in response to the service request 250, may also be provided as part of the decryption device 110. A decryption processor 215 in the decryption device 110 may be provided for decrypting the encrypted services 120 received from the one or more service providers.

The service request may be received by the SSL processor 210 and forwarded from the SSL processor to the service selector 240. The service selector 240 may acquire the requested service from the one or more service providers as an encrypted requested service 120. The decryption processor 215 may then decrypt the encrypted requested service 120, providing decrypted requested service 230 to the service selector 240. The service selector 240 forwards the decrypted requested service to the SSL processor 210 as requested service 245. The SSL processor 210 re-encrypts the requested service 245 as an SSL encrypted service 225. The SSL encrypted service 225 is securely communicated from the decryption device 110 to the consumer device 100 (e.g., via data transport mechanism 205) as SSL encrypted service 105, where it can be decrypted.

The service selector 240 may acquire the requested service using standard service acquisition mechanisms. For example, a service identifier (e.g., a channel map number from a channel map) may be passed to the service selector 240 via a software API call (e.g., from processor 210). The service selector 240 then initiates a tuning operation to tune a tuner (not shown) to a specific frequency. In the case of digital services, the service selector 240 also handles signal (e.g., quadrature amplitude modulation (QAM)) lock, program table acquisition filtering, and ultimately service selection from the multiplex of services received.

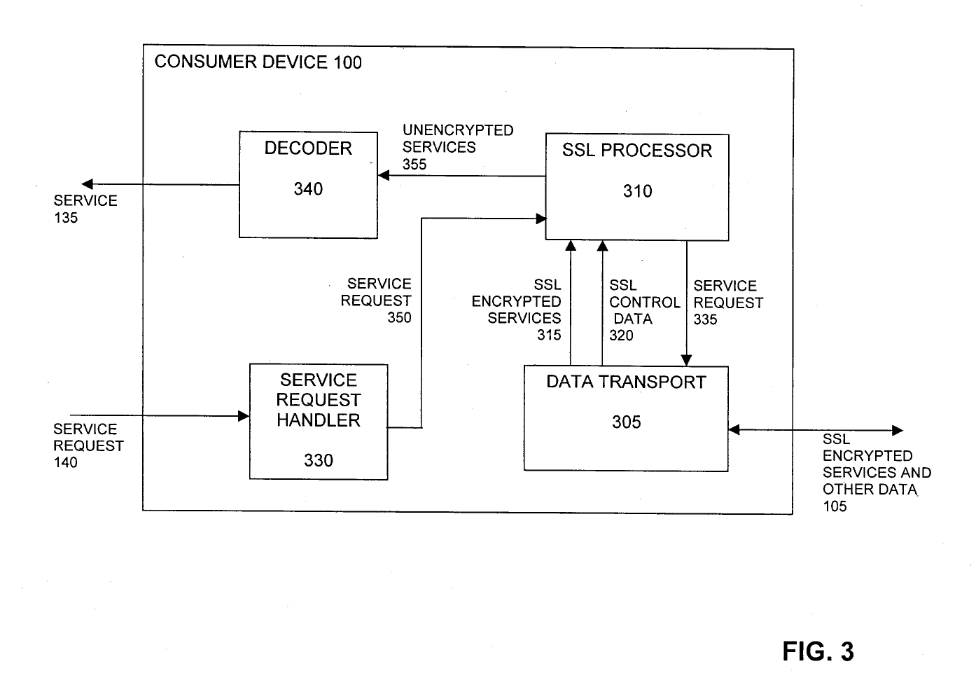

As shown in FIG. 3, the consumer device 100 may comprise a second SSL processor 310 for decrypting the re-encrypted service 315 and a decoder 340 for decoding the decrypted (i.e., unencrypted) requested service 355. A service request handler 330 receives the service request 140 from the user interface 130. The service request 350 is forwarded from the service request handler 330 to the second SSL processor 310. The second SSL processor 310 forwards the service request 335 on to the decryption device 110 via the data transport mechanism 305. The service request may then be processed by the decryption device 110 as discussed above in connection with FIG. 2. The SSL encrypted service 105 may be received by the consumer device 100 from the decryption device 110 at data transport mechanism 305, which forwards SSL control data 320 and SSL encrypted service 315 to SSL processor 310. The second SSL Processor 310 can then decrypt the SSL encrypted services 315 and forward the decrypted (unencrypted) service 355 to decoder 340 for decoding. The decoded service 135 can then be output for display.

In a further example embodiment, the decryption device 110 may be located at a television headend. In such an embodiment, the consumer device 100 may comprise a digital television terminal. The decryption device 110 may decrypt services received in a first encryption format and re-encrypt a requested service in a second encryption format for communication to the digital television terminal 100. The first encryption format may comprise secure socket layer (SSL) encryption. The second encryption format may comprise an encryption format compatible with a television system network distribution system.

The decryption device 110 may include multiple decryption processors 215 for decrypting multiple services received from multiple service providers 150. The decryption device 110 is enabled to process multiple service requests received simultaneously from multiple digital consumer devices 100.

The consumer device 100 may be one of a plurality of consumer devices in a television system network. The decryption device 110 may be a digital television terminal in a television system network. The consumer device 100 may be enabled to securely access the decryption device 110 from a remote location. For example, the consumer device 100 may securely access the decryption device 110 via a broadband connection from the remote location.

The encrypted services 120 may comprise one of pay-per-view services, television programs, Internet content, streaming media content, audio content, video content, audiovisual content, or the like.

The service providers 150 may comprise at least one of an Internet provider, a telephone provider, a cable television provider, a satellite television provider, an off-air television provider, a streaming media provider, or a radio station.

The decryption device 110 may be located within a local network. Multiple consumer devices 100 within the network may be enabled to securely communicate with the decryption device 110. The decryption device 110 may comprise a plurality of decryption processors 215 for decrypting multiple services in response to a multiple service requests. The decryption device 110 may comprise a digital television terminal. The multiple consumer devices 100 may each comprise one of a personal computer, an Internet appliance, a personal digital assistant, a cellular telephone, or the like. The decryption device 110 may comprise one of a secure broadband gateway (SBG) or a secure broadband modem (SBM).

The re-encrypted requested service may be decrypted and decoded at the decryption device 110 and then output from the decryption device 110, rather than or in addition to being passed on to the consumer device 100. For example, the decryption device 110 may be a television terminal and the consumer device 100 may comprise an Internet appliance. In addition to enabling secure communications of the service from the television terminal to the Internet appliance, the television terminal is enabled to decrypt the re-encrypted services and decode them for display on the television. Alternatively, a separate path may be provided which enables the television terminal to decrypt and decode the service as originally received for display on the television (i.e. without the need to re-encrypt and then decrypt again).

The present invention may be used, for example, to enable the secure distribution of video and/or audio services from consumers' homes to remote locations. As one example, a consumer may purchase a service from a television provider for a digital video recorder enabled television “set-top” terminal. The consumer, while traveling, could login to the terminal from a laptop using a broadband connection and securely stream content that has been recorded on the terminal to their remote laptop. Various other uses for the present invention will be apparent from those skilled in the art from the disclosure above.

It should now be appreciated that the present invention provides advantageous methods and apparatus for integrating one-way and two-way security systems, such as consumer devices and decryption devices, to enable increased distribution of services in a secure manner.

Although the invention has been described in connection with various illustrated embodiments, numerous modifications and adaptations may be made thereto without departing from the spirit and scope of the invention as set forth in the claims.

What is claimed is:

1. Apparatus for integrating one-way and two-way security systems to enable secure distribution of services comprising:
a decryption device enabled to securely receive and decrypt encrypted services from one or more service providers;
a consumer device enabled to securely communicate with said decryption device;
a user interface associated with said consumer device for initiating a service request for a requested service from said one or more service providers;
wherein:
said service request is communicated from said consumer device to said decryption device;
said requested service is acquired by said decryption device from said one or more service providers in response to said service request as an encrypted requested service;
the acquired encrypted requested service is decrypted by said decryption device;
said requested service is re-encrypted and securely communicated from said decryption device to said consumer device; and
said re-encrypted requested service is decrypted and decoded at said consumer device to provide said requested service.

2. Apparatus in accordance with claim 1, wherein said service request is communicated via one of a secure channel or a non-secure channel.

3. Apparatus in accordance with claim 1, wherein said requested service is securely acquired by said decryption device.

4. Apparatus in accordance with claim 1, wherein:
said requested service is received by said decryption device in an encrypted multiplex of services; and
said decryption device decrypts said multiplex in order to acquire said requested service.

5. Apparatus in accordance with claim 1, wherein:
said received encrypted services are received in a first encryption format; and
said re-encrypted requested service is encrypted in a second encryption format compatible with said consumer device.

6. Apparatus in accordance with claim 1, wherein said consumer device establishes a secure socket layer (SSL) connection with said decryption device.

7. Apparatus in accordance with claim 6, wherein the SSL connection is enabled via one of a Transmission Control Protocol/Internet Protocol (TCP/IP) transport scheme or an MPEG-2 transport scheme.

8. Apparatus in accordance with claim 6, wherein the SSL connection is enabled via a proprietary transport scheme.

9. Apparatus in accordance with claim 6, wherein the service request is securely communicated from the consumer device to said decryption device via the SSL connection.

10. Apparatus in accordance with claim 1, wherein:
the requested service is parentally controlled; and
the decryption device communicates a response to said consumer device requesting access information for said parental controlled service.

11. Apparatus in accordance with claim 10, wherein:
said access information is provided by a user via said interface;
said access information is securely communicated from said consumer device to said decryption device; and
in the event said access information is verified by said decryption device, the user is authorized to receive said requested service.

12. Apparatus in accordance with claim 10, wherein:
said access information comprises at least one of a personal identification number, a user name, and a password.

13. Apparatus in accordance with claim 1, wherein:
said requested service is a pay-per-view service; and
the decryption device communicates a response to the consumer device requesting payment or authorization information for said pay-per-view service.

14. Apparatus in accordance with claim 13, wherein:
said payment or authorization information is provided by a user via said user interface;
said payment or authorization information is securely communicated from said consumer device to said decryption device; and
in the event said payment or authorization information is verified by said decryption device, the user is authorized to receive said requested pay-per-view service.

15. Apparatus in accordance with claim 14, further comprising:
a smart card interface to enable said payment or authorization for said requested pay-per-view service.

16. Apparatus in accordance with claim 1, wherein:
said consumer device comprises one of an Internet appliance, a personal computer, a personal digital assistant, or a cellular telephone; and
said decryption device comprises one of a digital television terminal or a digital television.

17. Apparatus in accordance with claim 1, wherein said decryption device comprises:
a first secure socket layer (SSL) processor for enabling SSL communications and re-encrypting said requested service;
a service selector for acquiring the requested service from said one or more service providers in response to said service request as an encrypted requested service; and
a decryption processor for decrypting said encrypted services received from said one or more service providers.

18. Apparatus in accordance with claim 17, wherein:
said service request is received by said SSL processor;
said service request is forwarded from the SSL processor to the service selector;
the service selector acquires the requested service from said one or more service providers as an encrypted requested service;
said decryption processor decrypts said encrypted requested service;
the service selector forwards said requested service to the SSL processor;
said SSL processor re-encrypts the requested service as an SSL encrypted service;
said SSL encrypted service is securely communicated to said consumer device; and
said SSL encrypted service is decrypted at said consumer device.

19. Apparatus in accordance with claim 17, wherein said consumer device comprises:
a second SSL processor for decrypting said re-encrypted service; and
a decoder for decoding said decrypted requested service.

20. Apparatus in accordance with claim 1, wherein:
said decryption device is located at a television headend; and
said consumer device comprises a digital television terminal.

21. Apparatus in accordance with claim 20, wherein said decryption device decrypts services received in a first encryption format and re-encrypts said requested service in a second encryption format for communication to said digital television terminal.

22. Apparatus in accordance with claim 21, wherein:
said first encryption format comprises secure socket layer (SSL) encryption; and
said second encryption format comprises an encryption format compatible with a television system network distribution system.

23. Apparatus in accordance with claim 20, wherein:
said decryption device includes multiple decryption processors for decrypting multiple services received from multiple service providers; and
said decryption device is enabled to process multiple service requests received simultaneously from multiple digital consumer devices.

24. Apparatus in accordance with claim 1, wherein said consumer device is one of a plurality of consumer devices in a television system network.

25. Apparatus in accordance with claim 1, wherein:
said decryption device is a digital television terminal in a television system network; and
said consumer device is enabled to securely access said decryption device from a remote location.

26. Apparatus in accordance with claim 25, wherein said consumer device securely accesses said decryption device via a broadband connection from said remote location.

27 Apparatus in accordance with claim 1, wherein said encrypted services comprise one of pay-per-view services, television programs, Internet content, streaming media content, audio content, video content, or audiovisual content.

28. Apparatus in accordance with claim 1, wherein said service providers comprise at least one of an Internet provider, a telephone provider, a cable television provider, a satellite television provider, an off-air television provider, a streaming media provider, or a radio station.

29. Apparatus in accordance with claim 1, wherein:
said decryption device is located within a local network; and
multiple consumer devices within said network are enabled to securely communicate with said decryption device.

30. Apparatus in accordance with claim 29, wherein:
said decryption device comprises a plurality of decryption processors for decrypting multiple services in response to a multiple service requests.

31. Apparatus in accordance with claim 29, wherein:
said decryption device comprises a digital television terminal; and
said multiple consumer devices each comprise one of a personal computer, an Internet appliance, a personal digital assistant, or a cellular telephone.

32. Apparatus in accordance with claim 29, wherein said decryption device comprises one of a secure broadband gateway (SBG) or a secure broadband modem (SBM).

33. Apparatus in accordance with claim 1, wherein:
said re-encrypted requested service is decrypted and decoded at said decryption device; and
said requested service is output from said decryption device.

34. Apparatus in accordance with claim 1, wherein said user interface comprises one of an interactive display device, a remote control device adapted for communication with said consumer device, a touch screen associated with said consumer device, a joystick associated with said consumer device, a mouse, or a touch pad associated with said consumer device.

35. A method for integrating one-way and two-way security systems to enable secure distribution of services, comprising:
initiating a service request for a requested service on a consumer device via a user interface;
communicating said service request from said consumer device to a decryption device;
enabling said requested service to be acquired by said decryption device as an encrypted requested service in response to said service request;
decrypting the acquired encrypted requested service at said decryption device;
re-encrypting said requested service at said decryption device;
securely communicating said requested service from said decryption device to said consumer device; and
decrypting and decoding said re-encrypted requested service at said consumer device to provide said requested service.

36. A method in accordance with claim 35, wherein said service request is communicated via one of a secure channel or a non-secure channel.

37. A method in accordance with claim 35, wherein said requested service is securely acquired by said decryption device.

38. A method in accordance with claim 35, wherein:
said requested service is received by said decryption device in an encrypted multiplex of services; and
said decryption device decrypts said multiplex in order to acquire said requested service.

39. A method in accordance with claim 35, wherein:
said received encrypted services are received in a first encryption format; and
said re-encrypted requested service is encrypted in a second encryption format compatible with said consumer device.

40. A method in accordance with claim 35, further comprising:
establishing of a secure socket layer (SSL) connection by said consumer device with said decryption device.

41. A method in accordance with claim 40, wherein the SSL connection is enabled via one of a Transmission Control Protocol/Internet Protocol (TCP/IP) transport scheme or an MPEG-2 transport scheme.

42. A method in accordance with claim 40, wherein the SSL connection is enabled via a proprietary transport scheme.

43. A method in accordance with claim 40, further comprising:
securely communicating the service request from the consumer device to said decryption device via the SSL connection.

44. A method in accordance with claim 35, wherein:
the requested service is parentally controlled; and
the decryption device communicates a response to said consumer device requesting access information for said parental controlled service.

45. A method in accordance with claim 44, further comprising:
providing said access information to said consumer device by a user via said interface;
securely communicating said access information from said consumer device to said decryption device;
verifying said access information; and
authorizing receipt of said requested service if said access information is verified by said decryption device.

46. A method in accordance with claim 44, wherein:
said access information comprises at least one of a personal identification number, a user name, and a password.

47. A method in accordance with claim 35, wherein:
said requested service is a pay-per-view service; and
the decryption device communicates a response to the consumer device requesting payment or authorization information for said pay-per-view service.

48. A method in accordance with claim 47, further comprising:
providing said payment or authorization information by a user via said user interface;
securely communicating said payment or authorization information from said consumer device to said decryption device;
verifying said payment or authorization information; and
authorizing receipt of said requested service in the event said payment or authorization information is verified by said decryption device.

49. A method in accordance with claim 48, further comprising:
enabling said payment or authorization for said requested pay-per-view service via a smart card interface.

50. A method in accordance with claim 35, wherein:
said consumer device comprises one of an Internet appliance, a personal computer, a personal digital assistant, or a cellular telephone; and
said decryption device comprises one of a digital television terminal or a digital television.

51. A method in accordance with claim 35, wherein said decryption device comprises:
a first secure socket layer (SSL) processor for enabling SSL communications and re-encrypting said requested service;
a service selector for acquiring the requested service from said one or more service providers in response to said service request as an encrypted requested service; and
a decryption processor for decrypting said encrypted services received from said one or more service providers.

52. A method in accordance with claim 51, further comprising:
receiving said service request by said SSL processor;
forwarding said service request from the SSL processor to the service selector;
acquiring the requested service by the service selector from said one or more service providers as an encrypted requested service;
decrypting said encrypted requested service by said decryption processor;
forwarding said requested service by the service selector to the SSL processor;
re-encrypting said requested service as an SSL encrypted service;
securely communicating said SSL encrypted service to said consumer device; and
decrypting said SSL encrypted service at said consumer device.

53. A method in accordance with claim 51, wherein said consumer device comprises:
a second SSL processor for decrypting said re-encrypted service; and
a decoder for decoding said decrypted requested service.

54. A method in accordance with claim 35, wherein:
said decryption device is located at a television headend; and
said consumer device comprises a digital television terminal.

55. A method in accordance with claim 54, wherein said decryption device decrypts services received in a first encryption format and re-encrypts said requested service in a second encryption format for communication to said digital television terminal.

56. A method in accordance with claim 55, wherein:
said first encryption format comprises secure socket layer (SSL) encryption; and
said second encryption format comprises an encryption format compatible with a television system network distribution system.

57. A method in accordance with claim 54, wherein:
said decryption device includes multiple decryption processors for decrypting multiple services received from multiple service providers; and
said decryption device is enabled to process multiple service requests received simultaneously from multiple digital consumer devices.

58. A method in accordance with claim 35, wherein said consumer device is one of a plurality of consumer devices in a television system network.

59. A method in accordance with claim 35, wherein:
said decryption device is a digital television terminal in a television system network; and
said consumer device is enabled to securely access said decryption device from a remote location.

60. A method in accordance with claim 59, wherein said consumer device securely accesses said decryption device via a broadband connection from said remote location.

61 A method in accordance with claim 35, wherein said encrypted services comprise one of pay-per-view services, television programs, Internet content, streaming media content, audio content, video content, or audiovisual content.

62. A method in accordance with claim 35, wherein said service providers comprise at least one of an Internet provider, a telephone provider, a cable television provider, a satellite television provider, an off-air television provider, a streaming media provider, or a radio station.

63. A method in accordance with claim 35, wherein:
said decryption device is located within a local network; and
multiple consumer devices within said network are enabled to securely communicate with said decryption device.

64. A method in accordance with claim 63, wherein:
said decryption device comprises a plurality of decryption processors for decrypting multiple services in response to a multiple service requests.

65. A method in accordance with claim 63, wherein:
said decryption device comprises a digital television terminal; and
said multiple consumer devices each comprise one of a personal computer, an Internet appliance, a personal digital assistant, or a cellular telephone.

66. A method in accordance with claim 63, wherein said decryption device comprises one of a secure broadband gateway (SBG) or a secure broadband modem (SBM).

67. A method in accordance with claim 35, wherein:
said re-encrypted requested service is decrypted and decoded at said decryption device; and
said requested service is output from said decryption device.

68. A method in accordance with claim 35, wherein said user interface comprises one of an interactive display device, a remote control device adapted for communication with said consumer device, a touch screen associated with said consumer device, a joystick associated with said consumer device, a mouse, or a touch pad associated with said consumer device.

69. A decryption device comprising:
a service selector enabled to acquire an encrypted requested service from one or more service providers in response to a service request received from a consumer device;
a decryption processor enabled to decrypt the encrypted requested service; and
a secure socket layer (SSL) processor enabled for (i) providing SSL communications with the consumer device; and (ii) re-encrypting the requested service for secure communication to the consumer device.

70. A consumer device comprising:
a secure socket layer (SSL) processor enabled for providing SSL communications with an encryption device and decrypting re-encrypted services received from said encryption device; and
a decoder enabled to decode said decrypted requested service;
wherein:
said consumer device is enabled to communicate a service request to the decryption device for a requested service;
said requested service is acquired by said decryption device from one or more service providers in response to said service request as an encrypted requested service;
the acquired encrypted requested service is decrypted by said decryption device; and
said requested service is re-encrypted and securely communicated from said decryption device to said consumer device.
